(19) United States
(12) Patent Application Publication
(10) Pub. No.: US 2009/0096286 A1
(43) Pub. Date: Apr. 16, 2009

(54) HIGH VOLTAGE BATTERY IMPACT PROTECTION SYSTEM FOR AUTOMOTIVE VEHICLE

(76) Inventors: Derrick Scott Buck, Pendleton, IN (US); Jeff Dixon, Indianapolis, IN (US)

Correspondence Address: HOWARD & HOWARD ATTORNEYS PLLC, 450 West Fourth Street, Royal Oak, MI, 48067, US

(21) Appl. No.: 11/753,271

(22) Filed: May 24, 2007

Related U.S. Application Data
(60) Provisional application No. 60/803,178, filed on May 25, 2006.

(51) Int. Cl. H02H 7/18

(52) U.S. Cl. 307/10.7; 340/436

(57) ABSTRACT

A safety control assembly (10) for a vehicle (12,14) having a starter includes a plurality of battery modules (16) interconnected by a bus line (20) to form a circuit for supplying power to the starter. An interface circuit device interconnects the battery modules (16) to prevent the power supply between the battery modules (16) in response to a crash condition. The safety control assembly (10) of the present invention improves the crashworthiness response and effectiveness of the vehicle (12,14) and reduces the likelihood of injury of the driver and the passengers by diminishing a risk of an electrical shock to the passengers of the vehicle (12,14) and those trying to rescue the passengers injured during the collision.

### RELATED APPLICATIONS

This non-provisional application claims priority to provisional application Ser. Nos. 60/803,178 filed on May 25, 2006 and incorporated by reference herein in its entirety.

### FIELD OF THE INVENTION

The subject invention relates to battery modules, and more particularly to a safety system operably connected to the battery modules and adaptable to reduce voltage in the battery modules in response to a collision or other external or internal impacts on the battery modules.

### BACKGROUND OF THE INVENTION

Motor vehicles, such as, for example, hybrid vehicles use multiple propulsion systems to provide motive power. This most commonly refers to gasoline-electric hybrid vehicles, which use gasoline (petrol) to power internal-combustion engines (ICEs), and electric batteries to power electric motors. These hybrid vehicles recharge their batteries by capturing kinetic energy via regenerative braking. When cruising or idling, some of the output of the combustion engine is fed to a generator (merely the electric motor(s) running in generator mode), which produces electricity to charge the batteries. This contrasts with all-electric cars which use batteries charged by an external source such as the grid, or a range extending trailer.

The batteries and cells are important energy storage devices well known in the art. The batteries and cells typically comprise electrodes and an ion conducting electrolyte positioned therebetween. Battery modules that contain lithium ion batteries are increasingly popular with automotive applications and various commercial electronic devices because they are rechargeable and have no memory effect.

Today, most contemporary automobiles, such as typical gasoline cars, hybrid vehicles, and electric vehicles are equipped with numerous safety features that include air bags and energy absorbing devices connected to a steering column assembly. Energy absorption devices include mechanisms that permit a controlled collapse of the steering column, wherein the air bags, mounted on a wheel of the steering column assembly, are designed to deploy in the event of a collision to provide protection to the driver. In addition to the airbag, adjustable position columns are typically fitted with energy absorbing device including energy absorbing straps or the like, that allow the steering column to collapse during a collision at a controlled rate when impacted by the driver to offer additional protection to the driver.

It is known to provide sensors for sensing conditions in a vehicle. These vehicle condition sensors may include, for example, vehicle impact sensors, rollover sensors, seat position sensors, seat weight sensors, seatbelt latch sensors, seatbelt tension sensors, occupant position sensors, shaft torque sensors, steering wheel position sensors, fuel level sensors, engine condition sensors, and chassis condition sensors. Many of these vehicle condition sensors are mounted on vehicle parts that are movable relative to the remainder of the vehicle.

Vehicle condition sensors may provide information used to help control operation of various vehicle systems. For example, the operation of vehicle occupant protection devices, such as air bags, inflatable curtains (side air bags?), and seatbelt pretensioners, may be tailored according to information provided by seatbelt latch sensors, seatbelt tension sensors, seat position sensors, seat weight sensors, occupant position sensors, vehicle acceleration sensors, or a combination of such sensors. For instance, it is known to vary the pressure to which an inflatable vehicle occupant protection device is inflated according to factors such as crash severity, occupant size, occupant weight, and occupant position.

Alluding to the above, various designs of safety devices of automotive electric control circuits and methods of forming the same replete the art of safety devices used in automotive industry. One of such devices is disclosed in the U.S. Pat. No. 4,287,431 to Yasui et al., which teaches an electric control circuit of a safety apparatus for an automotive vehicle. The safety apparatus includes a pair of conventional primers to be fired electrically to supply fluid under pressure into an inflatable air bag. The primers are in parallel with each other by conductors and have a small internal resistance value. Collision sensors are provided on the front bumper of the vehicle and a central portion of the vehicle chassis respectively. Each of the sensors is in the form of a normally open switch to be closed upon deceleration of the vehicle in excess of a predetermined magnitude. The sensor has one end connected to the primers through a conductor and the conductors and the other end connected to the cathode of a diode through a conductor. The safety apparatus includes an actuator in series with an electric power source through a normally open switch to be electrically operated upon closure of the switch in the occurrence of a vehicle collision, a resistor is connected in parallel with the switch and has a predetermined resistance value defining an electric current applied to the actuator through the resistor to maintain the actuator inoperative.

The control circuit of the U.S. Pat. No. 4,287,431 to Yasui et al., further includes a differential amplifier for amplifying a terminal voltage appearing between the opposite ends of the actuator to generate an amplified voltage therefrom, a constant voltage generator for generating a constant voltage therefrom, a comparator for comparing the amplified voltage with the constant voltage to generate an output signal therefrom when the amplified voltage becomes lower or higher than the constant voltage, and an indicator for informing of malfunction of the control circuit in response to the output signal from the comparator. The battery is still charged with enough voltage to harm the passengers and those trying to rescue the passengers in case of a contact with damaged and externally exposed wiring or other components having a contact with the battery.

The United States Patent Application Publication No. 20060176158 to Fleming teaches a system having an electrical sensor for sensing a condition of a vehicle. The system also includes an energy harvesting device for providing electrical energy in response to the vehicle environment. The electrical energy is provided to the electrical sensor. The system also includes a device on the vehicle actuatable in response to the condition of the vehicle sensed by the sensor. The device is an inflator for an inflatable vehicle occupant protection device. The battery is still charged with enough voltage to harm the passengers and those trying to rescue the passengers in case of a contact with damaged and externally exposed wiring or other components having a contact with the battery.

Unfortunately, these vehicles still present a problem of an electric shock that may dramatically injure occupants of the vehicle as collision occurs or when the occupants try to exit the vehicle damaged by the collision.

One of the areas of continuous development and research in automotive industry today relates to systems and devices directed to reduction or even total elimination of the electric shock of the passengers of the vehicle and other people trying to assist the passengers injured in the collision.

### SUMMARY OF THE INVENTION

A safety system of the present invention is adaptable to be utilized in various configurations including and not limited to battery module having a variety of packaging configurations used in automotive vehicles. Preferably, the battery cells and lithium ion cells without limiting the scope of the present invention. The battery pack has a plurality of battery modules each presenting a quantity of battery cells. Each battery cell has a first electrode adjacent a first current collector and a second electrode of charge opposite from the first electrode and adjacent a second current collector and a separator layer positioned between the first and second electrodes with the first and second electrodes ionic conducting electrolyte therebetween.

The safety system of the present invention is designed to provide a high voltage battery impact protection for a vehicle. The safety system is also utilized in other application requiring the battery module as a power source and utilized by a human. The safety system of the present invention includes a plurality of battery modules interconnected by a bus line to form a circuit for supplying power to the vehicle system. An interface circuit device of the present invention interconnects the battery modules and is adaptable to eliminate the power supply between the battery modules in response to a crash condition.

A first switch is disposed on the bus line between one of battery packs and a second of the battery packs. A second switch is disposed on the bus line between the second of the battery packs and a third of the battery packs. The first and second switches are adaptable to move between a closed position to supply the power generated by the battery packs through the bus line and an opened position to prevent the power supply between the battery packs in response to the collision.

A power management control system operatively communicates with each of the battery packs and the interface circuit device. A first sensor is electrically communicated with the interface circuit device. The first sensor is utilized to sense an external impact thereby signaling the interface circuit device the external impact sensed. A second sensor is electrically communicated with the power management control system. The second sensor is utilized to sense an internal impact and to signal the power management control system the internal impact sensed.

An advantage of the present invention is to improve the crashworthiness response and effectiveness of a safety system of the vehicle and reducing the likelihood of injury of the driver and the passengers.

Another advantage of the present invention is to provide a battery assembly having efficient and improved safety characteristics by diminishing a risk of an electrical shock to passengers of the vehicle and those trying to rescue the passengers injured during the collision.

Still another advantage of the present invention is to provide a battery assembly that reduces the weight by eliminating connecting hardware and multiple redundant parts and which can easily be serviced.

Still another advantage of the present invention is to provide a battery assembly that reduces manufacturing costs due to simplified assembly pattern.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of a high voltage battery impact protection system of the present invention;

FIG. 2 is a top and partial schematic view of the high voltage battery impact protection system installed on a vehicle body; and

FIG. 3 is a top and partial schematic view of the high voltage battery impact protection system installed on a body of a pick-up truck.

### DETAILED DESCRIPTION OF THE PREFERRED EMBODIMENT

Referring to the Figures, wherein like numerals indicate like or corresponding parts, a high voltage impact protection system (the system) of the present invention is generally shown at 10. The system 10 is used for protecting passengers (not shown) located inside a passenger vehicle 12, a pick-up truck 14, and any other vehicles, without limiting the scope of the present invention. The system 10 also protects rescue personnel trying to assist injured passengers as collision occurred. The system 10 is adaptable for battery unit or module 16 adaptable to be utilized in various configurations including and not limited to any cell packaging configuration used in the automotive vehicle 12. The system 10 may also be employed in other, i.e. non-automotive applications, without limiting the scope of the present invention.

Those skilled in electrochemical art will appreciate that the battery module 16 is an electrochemical device that stores and provides electrical energy. When the module 16 is connected to an external load, an energy conversion occurs that results in current flow through a circuit to operate the load. The battery module 16 is a storage device on the vehicle's 12 and 14 electrical system and plays an important role in the operation of the starting, charging, ignition, and accessory circuits. However, large demand placed on the battery module 16 occurs when it must supply current to operate the some systems of the vehicle 12 and 14. As such, lithium battery is both known and expected to grow within the automotive market and to replace current types of batteries, especially with introduction of economical and environmentally friendly hybrid vehicles.

Each battery module 16 includes a plurality of cells (not shown). Preferably, each cell is a lithium cell without limiting the scope of the present invention. Those skilled in the battery art will appreciate that other cells can be utilized with the present invention. Preferably, each battery module 16 includes multiple rows of battery cells (not shown), with each row includes five modules of the cells. Each module of the cells (not shown) are interconnected with one another in the pattern known to those skilled in the battery art and extend along each row being electrically connected in relationship with one another. The battery module 16 is adaptable to be utilized in various configurations including and not limited to an overlapping battery cell packaging configuration, a vertical stack battery cell packaging configuration, and other configurations, without limiting the scope of the present invention.

Each cell includes a plurality of battery components (not shown) co-acting between one and the other ionic conducting electrolyte there between as known to those skilled in a lithium battery art. A first electrode is adjacent a first current collector and a second electrode of charge opposite from the first electrode is adjacent a second current collector. A separator layer is positioned between the first and second electrodes with the first and second electrodes containing electrolyte therebetween.

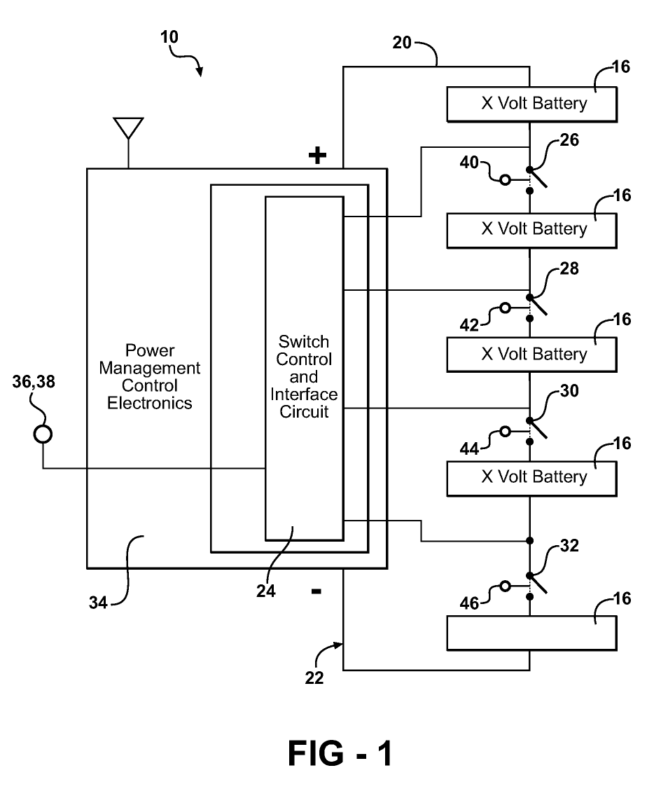

Referring back to FIG. 1, the system 10 of the present invention includes a bus line 20 interconnecting the battery modules 16, completing a circuit through 22 for supplying power to the starter. An interface circuit device 24 of the present invention interconnects the battery modules 16 and is adaptable to prevent the power current supply between the battery modules 16 in response to a crash condition. A plurality of switches 26, 28, 30, and 32 are disposed along the bus line and between the battery modules 16. Each switch 26, 28, 30, and 32 is adaptable to move or to be switched between a closed position to supply the power generated by the battery modules 16 through the bus line 20 and an opened position to prevent the power supply between the battery modules 16 in response to the collision. A power management control system 34 is operatively communicated with each of the battery modules 16 and the interface circuit device 24.

A plurality of sensors 36 and 38 are supported by the vehicle 12 for sensing the internal and/or external impacts and for sending an alert signal to the power management control system 34 and to the interface circuit device 24 thereby regulating the manipulation of the switches 26, 28, 30, and 32 between the closed position to the opened position as collision occurs. One of the sensors, i.e. the external sensor 36 is electrically communicated with the interface circuit device 24. The external sensor 36 is utilized to sense an external impact thereby signaling the interface circuit device 24 the external impact being sensed.

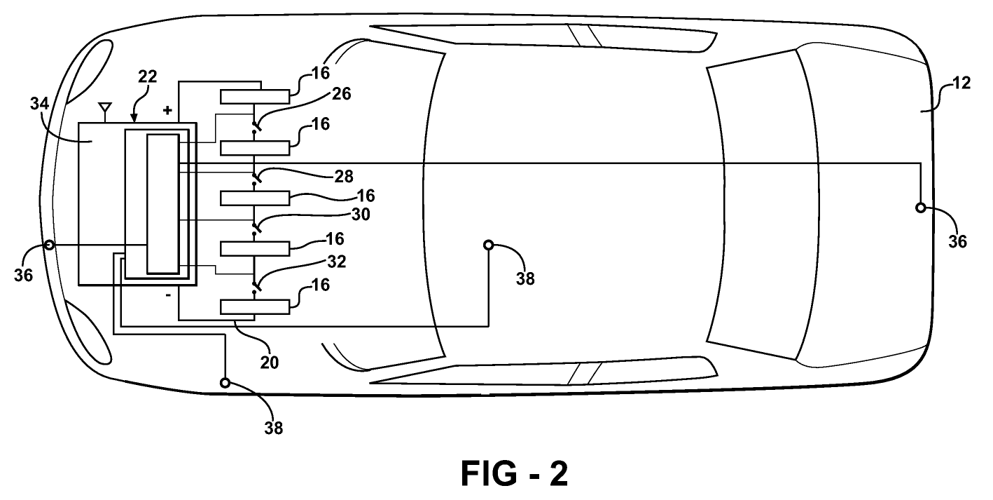

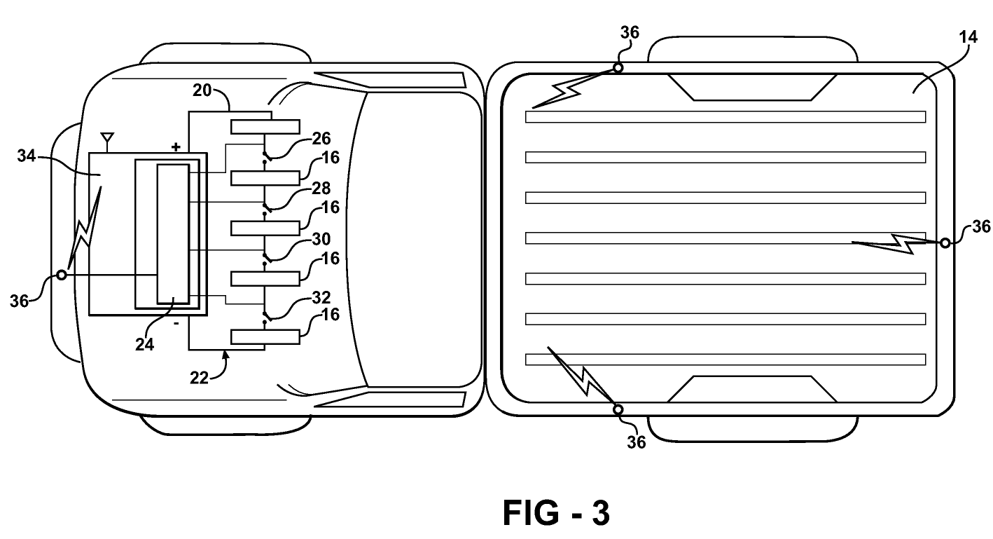

A second sensor, i.e. the internal sensor 38 is electrically communicated with the power management control system 34. The internal sensor 38 is utilized to sense an internal impact and to signal the power management control system 34 the internal impact sensed. Alternatively, each sensor 36 and 38 may be selectively and interchangeably connected to either the interface circuit device 24 or to the power management control system 34, without limiting the scope of the present invention. The system 10 may include a plurality of the external and internal sensors 36 and 38 installed about the periphery of the vehicle 12 as shown in FIGS. 2 and 3.

Alluding to the above, as the collision occurs, the external sensor 36 will sense an external impact and will sense an alert signal to the interface circuit device 24. The power interface circuit device 24 will send a command signal to each switch 26, 28, 30, and 32 directing them to switch from the closed position, as shown in phantom, to the opened position thereby preventing the power supply between the battery modules 16 in response to the collision. If the impact is minimal and is not sensed by the external sensor 36, the back up application, i.e. the internal sensor 38 will sense the internal impact, such as any possible impact within the vehicle, or the like, and will signal the power management control system 34, which is operatively communicated with each of the battery modules 16 and the interface circuit device 24, to send a command signal to each of the switches 26, 28, 30, and 32 directing them to switch from the closed position to the opened position thereby preventing the power supply between the battery modules 16 in response to the collision. Each battery module 16 may have a potential of carrying voltage enough to detriment the human being.

Referring to FIG. 1, the system 10 includes a plurality of switching elements 40, 42, 44, and 46 connected to each switches 26, 28, 30, and 32. Each switching element 40, 42, 44, and 46 presents a break-away devices adaptable for opening the switches 26, 28, 30, and 32 in response to sensed at least one the internal impact and external impact on the vehicle 12. Each said break-away device may also include a fuse responsive to at least one internal impact, external impact or current event on the vehicle 12 or 14. Those skilled in the art will appreciate that other switching elements may be used with the present invention including, but not limited to, various permanent opening devices, latching switches or squibs.

A plurality of the battery modules 16 may fatally injure the human being. During the collision, the wiring of the automotive power systems and even the pack case may be exposed openly through damaged parts of the vehicle 12. If unnoticed, it may cause a shock leading to a death or severe body harm. As such, the system 10 of the present invention is directed to prevent these harms from happening by minimizing voltage in each of the battery modules 16 to a level that is non-fatal if contacted by normal human body model.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A safety system for vehicle having at least an electrical system, said safety system comprising;
a first battery module and a second battery module connected in parallel relation to each other;
a buss line connected to said first battery module and second battery module thereby forming a circuit for supplying electric power from said first battery module and second battery module to the electrical system; and
first and second switching elements of said buss line connected in series to said first and second battery modules with said first and second switching elements movable between closed mode for supplying electric power from said first and second battery modules through said buss line for the electrical system and opened mode as said first and second switching elements terminate supply of electric power to the electrical system as at least one of internal impact and external impacts on the vehicle is sensed.

2. A safety system as set forth in claim 1 including a third battery module with said first switching element disposed on said buss line between said third battery module and said first battery module and said second switching element disposed on said buss line between said second battery module and said first battery module.

3. A safety system as set forth in claim 2 wherein each battery module presents a plurality of battery cells each having a first electrode adjacent a first current collector and a second electrode of charge opposite from said first electrode and adjacent a second current collector and a separator layer positioned between said first and second electrodes with said first and second electrodes ionic conducting electrolyte therebetween.

4. A safety system as set forth in claim 3 wherein said first switching element and said second switching element are further defined by a switch.

5. A safety system as set forth in claim 4 wherein each said first switching element and said second switching element includes break-away devices, respectively, for opening said first and second switching elements in response to sensed at least one in internal impact and external impact on the vehicle.

6. A safety system as set forth in claim 5 wherein each said break-away device includes a fuse responsive to at least one in internal impact and external impact on the vehicle.

7. A safety system as set forth in claim 6 wherein each said break-away device includes a shear container to hold said fuse disposed therein.

8. A safety system as set forth in claim 7 including a power management control system operatively communicating with each of said first and second and third battery modules, said buss line, said first and second switching elements, said break-away devices connected with one another to form an interface circuit device.

9. A safety system as set forth in claim 8 including at least one sensor electrically communicated with said interface circuit device with said first sensor sensing at least one of external impact and internal impact and signaling said interface circuit device at least one of external impact and internal impact on the vehicle is sensed.

10. A vehicle having a safety system for vehicle having an electrical system, said vehicle comprising:
a chassis;
a first battery module and a second battery module supported on said chassis and connected in at least one of series and parallel relation to each other;
a buss line connected to said first battery module and second battery module thereby forming a circuit for supplying electric power from said first battery module and second battery module to the electrical system;
an internal sensor and an external sensor for sensing internal impact and external impact onto said vehicle; and
first and second switching elements of said buss line connected in series to said first and second battery modules with said first and second switching elements movable between closed mode for supplying electric power from said first and second battery modules through said buss line and opened mode as said first and second switching elements terminate supply of electric power to the electrical system as at least one of said internal and external sensors sense at least one of internal impact and external impact on the vehicle.

11. A vehicle as set forth in claim 10 including a third battery module with said first switching element disposed on said buss line between said third battery module and said battery module and said second switching element disposed on said buss line between said second battery module and said first battery module.

12. A vehicle as set forth in claim 10 wherein each battery module presents a plurality of battery cells each having a first electrode adjacent a first current collector and a second electrode of charge opposite from said first electrode and adjacent a second current collector and a separator layer positioned between said first and second electrodes with said first and second electrodes ionic conducting electrolyte therebetween.

13. A vehicle as set forth in claim 10 wherein said first switching element and said second switching element are further defined by break-away devices, respectively, for opening said first and second switching elements in response to sensed at least one in internal impact and external impact on the vehicle, each said break-away device includes a fuse responsive to at least one in internal impact and external impact on the vehicle and a shear container to hold said fuse disposed therein.

14. A vehicle as set forth in claim 10 including a power management control system operatively communicating with each of said first and second and third battery modules, said buss line, said first and second switching elements, said break-away devices connected with one another to form an interface circuit device.

15. A vehicle as set forth in claim 10 including at least one sensor electrically communicated with said interface circuit device with said first sensor sensing at least one of external impact and internal impact and signaling said interface circuit device at least one of external impact and internal impact on the vehicle is sensed.

16. A method of making a safety system for vehicle having an electrical system, said method comprising the steps of:
connecting a first battery module and a second battery module by a buss line to form a circuit for supplying electric power from the first battery module and the second battery module to the electrical system;
connecting first and second switching elements to the buss line between the first battery module and the second battery module with the first and second switching elements movable in closed mode to supply electric power from the first battery module and the second battery module through the buss line for the electrical system; and
sensing as at least one of internal impact and external impact on the vehicle to move the first and second switching elements from closed mode to opened mode to terminate supply of electric power to the electrical system.

17. A method as set forth in claim 16 including the step of connecting a third battery module with the first switching element disposed on the buss line between the third battery module and the battery module and the second switching element disposed on the buss line between the second battery module and the first battery module.

18. A method as set forth in claim 16 including the step of connecting a pair of break-away devices to the first and second switching elements to open the first and second switching elements in response to sensed at least one in internal impact and external impact on the vehicle.

19. A method as set forth in claim 16 including the step of connecting a power management control system to the first and second and third battery modules, the buss line, the first and second switching elements, the break-away devices connected with one another to form an interface circuit device.

20. A method as set forth in claim 16 including the step of connecting at least one sensor to the interface circuit device to sense at least one of external impact and internal impact and to signal the interface circuit device at least one of external impact and internal impact on the vehicle is sensed.

21. A safety control assembly for a vehicle having a starter, said vehicle comprising;
a plurality of battery modules interconnected by a buss line to form a circuit for supplying power to the starter,
at least one switch disposed on said buss line plurality and
an interface circuit device interconnecting said battery modules and adaptable to prevent the power supply between said battery modules in response to a crash condition.

22. A safety control assembly as set forth in claim 21 wherein said interface circuit device is further defined by a first switch disposed on said bus line between one of said battery modules and a second of said battery modules and a second switch disposed on said bus line between said second of said battery modules and a third of said battery modules with said first and second switches adaptable to move between a closed position to supply the power generated by said battery modules through said bus line and an opened position to prevent the power supply between said battery modules in response to the collision.

23. A safety control assembly as set forth in claim 21 wherein each battery pack presenting a first cell and a second cell adjacent said first cell with each said first and second cells having a first electrode adjacent a first current collector and a second electrode of charge opposite from said first electrode and adjacent a second current collector and a separator layer positioned between said first and second electrodes with said first and second electrodes ionic conducting electrolyte therebetween.

24. A safety control assembly as set forth in claim 21 including a power management control system operatively communicating with each of said battery modules and said interface circuit device.

25. A safety control assembly as set forth in claim 21 including a first sensor electrically communicated with said interface circuit device with said first sensor sensing an external impact and signaling said interface circuit device the external impact sensed and a second sensor electrically communicated with said power management control system with said second sensor sensing an internal impact and signaling said power management control system the internal impact sensed.
